(19) United States
(12) Patent Application Publication
(10) Pub. No.: US 2023/0188051 A1
(43) Pub. Date: Jun. 15, 2023

(54) METHOD FOR CONTROLLING AN ACTIVE RECTIFIER OF A WIND POWER INSTALLATION

(71) Applicant: Wobben Properties GmbH, Aurich (DE)

(72) Inventors: Roberto Rosso, Aurich (DE); Johannes Warsinski, Unterschleißheim (DE)

(21) Appl. No.: 18/063,330

(22) Filed: Dec. 8, 2022

(30) Foreign Application Priority Data
Dec. 9, 2021 (EP) 21213468.8

(51) Int. Cl. H02M 7/217; H02K 7/18

(52) U.S. Cl. CPC H02M 7/217; H02K 7/183

(57) ABSTRACT

A method for controlling a converter, preferably a generator-side active rectifier of a power converter of a wind power installation. The method includes specifying a target value for the converter, specifying a carrier signal for the converter, capturing an actual value, determining a distortion variable from the target value and the actual value and determining driver signals for the converter on the basis of the distortion variable and the carrier signal.

### BACKGROUND

### Technical Field

The present invention relates to a method for controlling a converter, preferably a generator-side active rectifier of a power converter of a wind power installation.

### Description of the Related Art

In the field of electrical energy producers, in particular in wind power or photovoltaic installations, converters are usually used to produce power. In this case, the converters are often in the form of so-called converter systems, that is to say a plurality of converters or converter modules or converter submodules are interconnected, preferably in parallel, in particular in order to form a higher-power converter system.

In this case, the converters or the converter systems can be controlled by means of a wide variety of methods, for example by means of a hysteresis method, such as the tolerance band method, or by means of a modulation method, such as pulse width modulation.

The hysteresis methods are usually in the form of direct closed-loop current control methods with a closed control loop and have a fast dynamic response and a high degree of robustness with, in particular, a non-linear closed-loop control behavior and broadband noise.

The modulation methods usually have a fixed clock frequency, resulting in harmonics at a multiple of the modulation frequency which are often in the audible range. In contrast, selecting accordingly higher modulation frequencies results in problems with electromagnetic compatibility (for short: EMC) and in higher loads inside the converters or converter systems.

Previously known methods have the disadvantage, in particular, of the broadband noise, on the one hand, and the lack of a dynamic response and audible harmonics, on the other hand.

### BRIEF SUMMARY

Provided is a method for controlling converters, in particular active rectifiers of a wind power installation, which method has only little current ripple in the generator and therefore results in low force fluctuations in the air gap of the generator and in less noise. Provided is a method for controlling a converter, preferably a generator-side active rectifier of a power converter of a wind power installation, comprising the steps of: specifying a target value for the converter; specifying a carrier signal for the converter; capturing an actual value; determining a distortion variable from the target value and the actual value; and determining driver signals for the converter on the basis of the distortion variable and the carrier signal. In particular, a method for controlling an active rectifier of a wind power installation is therefore proposed, which method determines the driver signals for the active rectifier, in particular directly, from a measurement error, preferably without calculating additional target voltage values in the process, as in the case of conventional pulse width modulations (PWM), for example.

The proposed method has the advantage, in particular, that general system parameters are not absolutely necessary since the driver signals are preferably determined from a measurement error. This means that the proposed method can be parameterized and implemented more easily than previously known PWM methods, for example.

According to one embodiment, a target value and a signal, in particular an additional signal, are first of all specified for the converter.

The target value is preferably a target specification for a physical variable, for example a current to be generated by the converter. The target value is preferably a target current value for an alternating current to be generated by an active rectifier, for example in the form of a value or a function.

The, in particular additional, carrier signal is, for example, a comparison signal or a ramp signal. The carrier signal is preferably a triangular signal.

More preferably, the amplitude and/or the frequency and/or the period and/or the width of the carrier signal can be set. The amplitude and/or the frequency and/or the period and/or the width of the carrier signal is/are particularly preferably varied during ongoing operation, in particular in order to produce so-called smearing of the frequency band.

The frequency of the carrier signal is preferably selected on the basis of structural dynamic designs, for example in order to minimize the effects on the noise emissions of a corresponding generator. If the method described herein is used, for example, to control an active rectifier which is connected to a generator, the carrier signal preferably has a frequency of between 200 Hz and 2500 Hz, more preferably between 500 Hz and 1500 Hz.

In a further step, an actual value is then captured and compared with the target value, in particular in order to determine a distortion variable.

The actual value is preferably a physical variable which corresponds, in particular, to the target value, for example the current generated by the converter. The actual value is preferably an actual current value, in particular of an alternating current generated by an active rectifier.

The distortion variable determined from the target value and the actual value, for example by means of a difference, can also be referred to as a measurement or closed-loop control error.

The method therefore has at least one control loop and is preferably in the form of a direct closed-loop current control method, in particular in order to generate a three-phase alternating current for a stator of a generator of a wind power installation.

In this case, the distortion variable is preferably formed from a difference between the target value and the actual value and, if the target value and the actual value represent a current, can also be referred to as a distortion current.

The distortion variable may therefore likewise be a value or a function; in particular, the distortion variable is a differential current which varies over time and represents a difference between the target current and the actual current of a converter, in particular an active rectifier.

The driver signals for the converter, in particular for the switches of the converter, preferably the switches of the active rectifier, are then determined from the distortion variable and the carrier signal. If the active rectifier is, for example, in the form of a B6C rectifier having six switches, in particular circuit breakers, six driver signals are then accordingly determined, one driver signal for each switch.

The driver signals may be determined, for example, by comparing the distortion variable with the carrier signal. For this purpose, the distortion variable is integrated to form a modulation signal and is compared with the carrier signal, for example, wherein the points of intersection between the modulation signal and the carrier signal form a trigger for generating a corresponding driver signal.

It is therefore proposed, in particular, that the driver signals are generated by comparing the distortion variable and/or an extended distortion variable and/or a modulation signal with the carrier signal.

If the carrier signal is a ramp signal, for example, the method is in the form of a so-called ramp comparison method (ramp comparison control).

The driver signals are therefore used, in particular, to switch the switches of the converter, in particular the switches of the active rectifier, preferably in order to generate an electrical alternating current in the stator of the generator of the wind power installation, which current corresponds substantially to the target value, that is to say a target current.

The method described herein therefore preferably also comprises the step of: switching at least one switch of the converter, in particular of the active rectifier, on the basis of the driver signals, in particular in such a manner that the converter, in particular the active rectifier, generates an electrical alternating current in the stator of the generator of the wind power installation, which current corresponds substantially to the target value.

The method described herein may be designed both with and without hysteresis in this case. The method described herein is preferably designed without hysteresis.

The method described herein makes it possible, in particular, to improve the current quality of a converter, in particular of an active rectifier.

If the method described herein is used for a generator-side active rectifier, the quality of the stator current of the generator can be considerably improved, thus reducing the noise emissions of the generator.

The distortion variable is preferably converted, in particular amplified and/or integrated, to form an extended distortion variable and/or a modulation signal that preferably takes into account at least one system state of the converter.

The distortion variable, that is to say in particular the difference between the target value and the actual value, is therefore amplified and/or integrated, for example, in particular in order to reduce a steady-state error.

In order to integrate the distortion variable, it is possible to implement, for example, an I element or a PI element in the control unit, wherein the parameters thereof are preferably set on the basis of the electrical phase section of the wind power installation, for example the stator inductance or the stator resistance.

Alternatively or additionally, the distortion variable may also be amplified, for example by a factor of between 2 and 10, in particular in order to improve the signal quality. In this case, the gain is preferably set on the basis of the electrical phase section of the wind power installation, for example on the basis of a stator inductance or a stator resistance.

A corresponding system state may also be taken into account.

The driver signals are then preferably accordingly determined on the basis of the extended distortion variable or the modulation signal and the carrier signal.

It is therefore also proposed, in particular, that the driver signals are generated by comparing the extended distortion variable or the modulation signal with the carrier signal, for example as shown in FIG. 6.

Alternatively or additionally, the driver signals are determined on the basis of an offset which takes into account an operating point of the converter, in particular.

It is therefore also proposed to alternatively or additionally take into account at least one operating point of the active rectifier and/or of the wind power installation by means of an offset.

The offset may be, for example, in the form of a compensation value, such as a compensation current, which takes into account an operating point of the active rectifier and/or of the wind power installation.

The offset is preferably determined off-line, for example by means of simulation or calculation, and is accordingly set in a control unit.

The offset is therefore preferably a calculated variable which takes into account an operating point, for example of the converter or of a generator or system connected to the converter.

The steady-state error can be minimized or eliminated by appropriately accurate selection of the offset.

In addition to the offset, at least one I or PI controller is preferably used to further minimize or eliminate precisely that steady-state error.

This makes it possible to increase the accuracy of the proposed method, in particular.

Alternatively or additionally, the driver signals are determined by means of feed-forward of the target value.

It is therefore also proposed, in particular, to minimize the influence of the integrated distortion variable by means of feed-forward of the target value, in particular in order to prevent oscillation of the controller.

Feed-forward therefore minimizes the effort of the controller, in particular if a variable that is dependent on the operating point is included in the controller, for example the offset described herein.

As a result, any I or PI controllers, for example, engage only if the distortion variable, that is to say the steady-state error, is too large.

Feed-forward therefore relieves the load on the converter closed-loop control.

The target value is preferably a target current value, in particular for a current of an electrical (stator) system of a generator of a wind power installation.

The method is therefore designed, in particular, as closed-loop current control, preferably for a generator-side active rectifier of a wind power installation.

The driver signals are also preferably determined on the basis of a target current value, in particular for an active rectifier.

The carrier signal for the converter is preferably for setting a single-phase current, preferably of an electrical (stator) system of a generator of a wind power installation.

It is therefore also proposed, in particular, that the method described herein is used to set the stator currents of a generator, in particular of a wind power installation, preferably individually.

In this case, it is proposed, in particular, to individually set each phase of a (stator) system of the generator.

For example, the distortion current is individually determined for each phase and is compared with the signal in order to accordingly individually determine the driver signals for each phase.

The distortion current is preferably present in abc coordinates for this purpose.

The carrier signal is preferably generated by a signal generator and has at least one of the following forms: triangular, sinusoidal, square-wave.

The signal for determining the driver signals is therefore preferably generated by a signal generator, for example as a triangular or sawtooth function.

For example, the triangular function has two symmetrical edges. The edges rise, for example, with an angle of between 30° and 60°, preferably between 40° and 50°, more preferably approximately 45°.

However, the triangular function may also be asymmetrical; for example, the rising edge has an angle of approximately 45° and the falling edge has an angle of approximately 60°.

The sawtooth function has at least one edge of 90°, for example the rising edge or the falling edge. The other edge then has, for example, an angle of between 30° and 60°, preferably between 40° and 50°, more preferably approximately 45°. The control variable is then compared with this carrier signal in order to generate the driver signals.

The method described herein is therefore preferably designed like or as a ramp comparison method, preferably with a triangle.

The carrier signal preferably has an amplitude and a frequency.

The distortion variable and/or the extended distortion variable and/or the modulation signal preferably has/have an amplitude and a frequency lower than the amplitude and/or the frequency of the carrier signal, in particular.

For example, the amplitude of the carrier signal is twice as large as the amplitude of the distortion variable.

It is therefore proposed, in particular, that the carrier signal has a larger amplitude than the amplitude of the signal with which it is compared, that is to say the distortion variable or the extended distortion variable or the modulation signal, for example.

In another embodiment, the amplitude of the carrier signal is normalized to 1, and the amplitudes of the signal with which it is compared are lower.

Alternatively or additionally, the amplitude of the carrier signal is constant or is varied.

Alternatively or additionally, it is also proposed that the carrier signal has a frequency, for example between 200 Hz and 2500 Hz, which is greater than the frequency of the signal with which it is compared, that is to say the distortion variable or the extended distortion variable or the modulation signal, for example.

The distortion variable has, for example, a frequency of between 10 Hz and 200 Hz, for example around 50 Hz or 60 Hz.

The actual value is preferably an actual current value, in particular for a current of an electrical (stator) system of a generator of a wind power installation.

For this purpose, the actual current value is preferably captured at the input of the converter, in particular at the input of the active rectifier, in particular as a three-phase alternating current.

The actual current value may be captured, for example, for an entire system, for example a three-phase stator system, as a total current and/or may be captured individually for each phase of the system.

The actual current value is preferably transformed or converted into d/q and/or abc coordinates, in particular in order to compare them with the d/q and/or abc coordinates of the target current value.

The actual value preferably comprises both a three-phase overall system and each phase of the overall system.

It is therefore also proposed, in particular, that the method takes into account both the entire three-phase (stator) system and each phase of this system individually.

This can be carried out, for example, by carrying out both a comparison in the overall system and a comparison in each phase. For this purpose, for example, the actual value can be compared with a target value in d/q coordinates and additionally or subsequently again in abc coordinates.

For this purpose, the overall system is preferably captured as a sum current in d/q coordinates.

Preferably, the target value and/or the actual value and/or the distortion variable and/or an offset is/are or is/are present in d/q coordinates.

It is therefore proposed, in particular, to carry out the method described herein at least partially in d/q coordinates, in particular in order to take into account the entire (stator) system. In particular, at least the overall system is taken into account as a sum current in d/q coordinates.

In addition, a further part of the method described herein may also be carried out in abc coordinates, in particular in order to take into account the individual phases of the (stator) system.

Transforming the actual and target values into d/q coordinates makes it possible, on the one hand, to considerably simplify the method and, on the other hand, to use a PI controller to control the converter, in particular the active rectifier, which does not have any steady-state error, in particular.

The d/q coordinates can then be converted into abc coordinates in order to individually control each phase, in particular.

The method described herein is preferably carried out for a first electrical (stator) system of a generator of a wind power installation using a first carrier signal and is likewise carried out in a parallel manner, in particular at the same time, for a second electrical (stator) system of the same generator using a second carrier signal, wherein the first carrier signal and the second carrier signal are substantially identical, but are offset with a phase angle with respect to one another, wherein the phase angle is, in particular, between 30° and 120°, preferably between 80° and 100°, in particular around approximately 90°.

It is therefore proposed, in particular, to use the method described herein for a generator of a wind power installation having two (stator) systems which are offset by 30°, for example, and are each connected to an active rectifier, wherein the active rectifiers are operated at the same time using the method described herein, in particular using substantially identical carrier signals which have a phase offset with respect to one another, however.

In the case of parallel (stator) systems, the method is therefore carried out, in particular, with a phase offset in the carrier signal.

It was recognized that a phase offset of approximately 90°, in particular, results in low-noise operation in the case of two parallel (stator) systems. The carrier signal is preferably varied during ongoing operation, in particular by means of a ramp function on the basis of the rotor speed of the generator of the wind power installation, for example by a value in a range between 0 and 10 per cent, preferably approximately 5 per cent.

It is therefore also proposed, in particular, not to use a constant carrier signal, but rather to change the carrier signal for determining the driver signals during ongoing operation, preferably on the basis of a rotor speed of the generator.

The amplitude and/or the frequency and/or the period and/or the width is/are particularly preferably varied during ongoing operation, in particular in order to produce so-called smearing of the frequency band.

For example, the carrier signal has a variable frequency which is varied using a ramp function, for example around a particular frequency, in particular with a period duration that is proportional, in particular indirectly proportional, to the number of pole pairs and/or the rotor speed of the generator.

This makes it possible, in particular, to reduce any harmonics in the alternating current, in particular such that smaller or no filters at all are needed to ensure low-noise generator operation.

In one example, the frequency of the carrier signal is between 500 Hz and 2500 Hz, for example 700 Hz, and is varied by approximately 5 per cent, that is to say 35 Hz.

Provided is a control unit (e.g., controller) which is configured to carry out a method described herein.

Provided is a wind power installation comprising a converter and a control unit (e.g., controller), wherein the converter is in the form of a power converter and is operated by means of the control unit using a method described herein.

The wind power installation is, for example, in the form of a buoyancy rotor with a horizontal axis of rotation and preferably has three rotor blades on an aerodynamic rotor on the windward side.

The electrical phase section of the wind power installation that is connected to the aerodynamic rotor comprises substantially a generator, a converter connected to the generator and a (network) connection connected to the converter in order to connect the wind power installation to an electrical wind farm network or an electrical supply network, for example.

The generator is preferably in the form of a synchronous generator, for example a separately excited synchronous generator or a permanently excited synchronous generator.

The converter is preferably in the form of a power converter. This means, in particular, that the converter is used to convert electrical power generated by the generator.

The converter is also preferably integrated in the wind power installation as a full converter. This means, in particular, that the entire electrical power generated by the generator is passed via the converter and is therefore converted by the latter.

The converter is preferably in the form of an AC converter, also referred to as an AC/AC converter. This means, in particular, that the converter has at least one rectifier and one inverter. The converter is particularly preferably in the form of a direct converter or as a converter with a DC voltage intermediate circuit. In one particularly preferred embodiment, the converter is in the form of a back-to-back converter.

The converter preferably has at least one generator-side active rectifier which is controlled by means of a control unit (e.g., controller) described herein and/or using a method described herein.

The generator preferably has two stator systems, in particular offset by 30°, which are each connected to an active rectifier and are each control separately from one another via a control unit (e.g., controller).

In this case, the control units operate, in particular, with a method described herein, wherein the methods have, in particular, a phase offset in the carrier signal, for example of approximately 90°.

### BRIEF DESCRIPTION OF THE SEVERAL VIEWS OF THE DRAWINGS

The present invention is explained in more detail below on the basis of the accompanying figures, wherein the same reference signs are used for identical or similar components or assemblies.

FIG. 1 schematically shows, by way of example, a perspective view of a wind power installation in one embodiment.

FIG. 2 schematically shows, by way of example, a structure of an electrical phase section of a wind power installation in one embodiment.

FIG. 3 schematically shows, by way of example, the structure of a converter.

FIG. 4A schematically shows, by way of example, the structure of a control unit (e.g., controller) of a converter in one embodiment.

FIG. 4B schematically shows, by way of example, the structure of a control unit (e.g., controller of a converter in one preferred embodiment.

FIG. 4C schematically shows, by way of example, the structure of a control unit (e.g., controller of a converter in a further preferred embodiment.

FIG. 4D schematically shows, by way of example, a control module (e.g., control circuit) of a control unit (e.g., controller) for varying a frequency of the signal.

FIG. 5 schematically shows, by way of example, the sequence of a method for controlling a converter in one embodiment.

FIG. 6 schematically shows, by way of example, determination of a driver signal for the converter on the basis of the distortion variable and the carrier signal.

### DETAILED DESCRIPTION

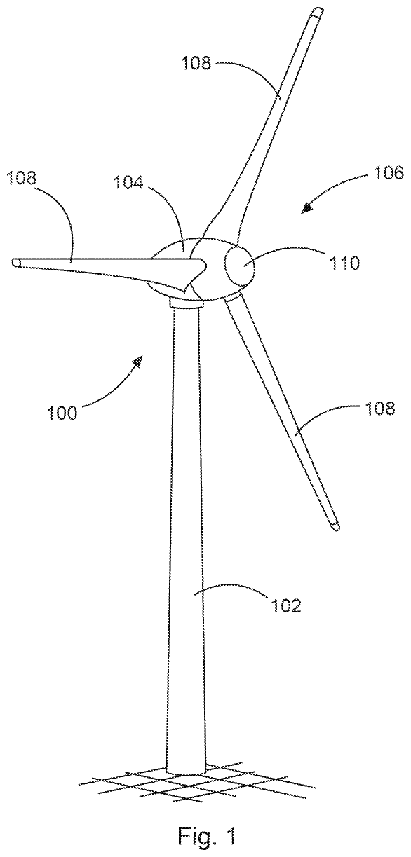

FIG. 1 schematically shows, by way of example, a perspective view of a wind power installation 100.

The wind power installation 100 is in the form of a buoyancy rotor with a horizontal axis and three rotor blades 200 on the windward side, in particular as horizontal rotors.

The wind power installation 100 has a tower 102 and a nacelle 104.

An aerodynamic rotor 106 with a hub 110 is arranged on the nacelle 104.

Three rotor blades 108 are arranged on the hub 110, in particular in a symmetrical manner with respect to the hub 110, preferably in a manner offset by 120°.

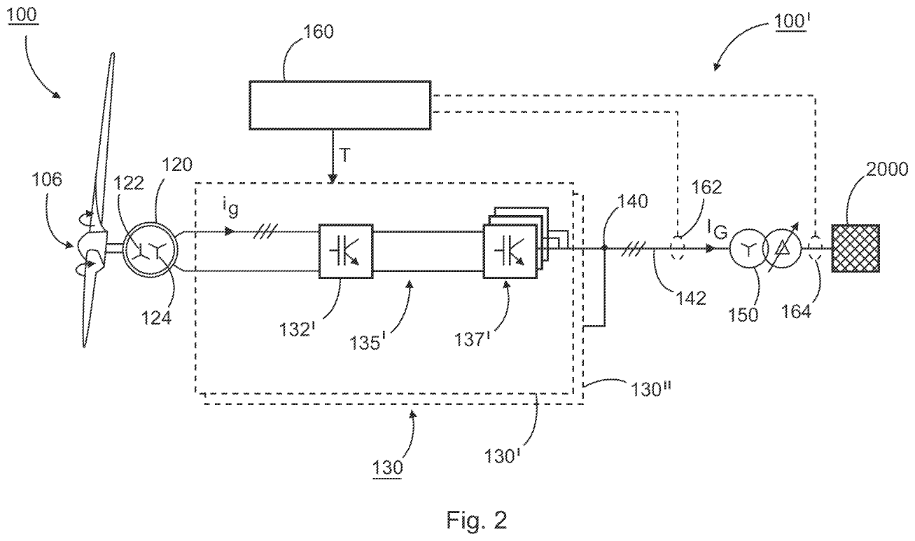

FIG. 2 schematically shows, by way of example, an electrical phase section 100′ of a wind power installation 100, as preferably shown in FIG. 1.

The wind power installation 100 has an aerodynamic rotor 106 which is mechanically connected to a generator 120 of the wind power installation 100.

The generator 120 is preferably in the form of a 6-phase synchronous generator, in particular with two three-phase systems 122, 124 which are phase-shifted through 30° and are decoupled from one another.

The generator 120 is connected to an electrical supply network 2000 or is connected to the electrical supply network 2000 via a converter 130 and by means of a transformer 150.

In order to convert the electrical power generated by the generator 120 into a current iG to be fed in, the converter 130 has in each case at least one converter module 130′, 130″ for each of the electrical systems 122, 124, wherein the converter modules 130′, 130″ are substantially structurally identical.

The converter modules 130′, 130″ have an active rectifier 132′ at a converter module input.

The active rectifier 132′ is electrically connected to an inverter 137′, for example via a DC voltage line 135′ or a DC voltage intermediate circuit.

The converter 130 or the converter modules 130′, 130″ is/are preferably in the form of (a) direct converter(s) (back-to-back converter).

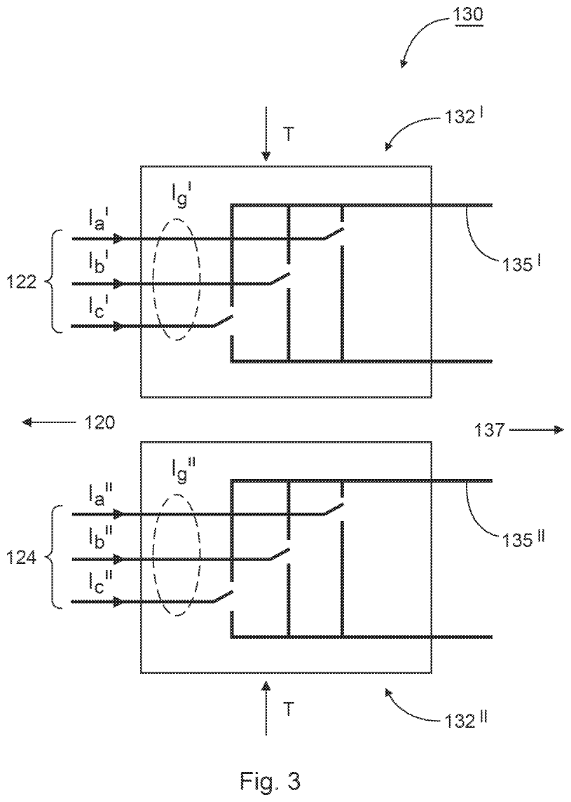

The method of operation of the active rectifiers 132′, 132″ of the converter 130 and the control thereof are explained in more detail in FIG. 3, in particular.

The two electrically three-phase systems 122, 124 which are decoupled from one another on the stator side are combined, for example on the network side, at a node 140 to form a three-phase overall system 142 which carries the total current iG to be fed in.

In order to feed the total current iG to be fed in into the electrical supply network 2000, a wind power installation transformer 150 is also provided at the output of the wind power installation, which transformer is preferably star-delta connected and connects the wind power installation 100 to the electrical supply network 2000.

The electrical supply network 2000, to which the wind power installation 100, 100′ is connected by means of the transformer 150, may be, for example, a wind farm network or an electrical supply or distribution network.

In order to control the wind power installation 100 or the electrical phase section 100′, a wind power installation control unit (e.g., controller) 160 is also provided.

In this case, the wind power installation control unit 160 is configured, in particular, to set a total current iG to be fed in, in particular by controlling the active rectifiers 132′, 132″ or inverters

In this case, the active rectifiers 132′, 132″ are controlled, in particular, as described herein, preferably by means of or on the basis of the driver signals T.

The wind power installation control unit 160 is preferably also configured to capture the total current iG using a current capture means 162. The currents of each converter module 137′ in each phase are preferably captured for this purpose, in particular.

In addition, the control unit also has voltage capture means 164 which are configured to capture a network voltage, in particular of the electrical supply network 2000.

In one particularly preferred embodiment, the wind power installation control unit 160 is also configured to also capture the phase angle and the amplitude of the current iG to be fed in. The wind power installation control unit 160 also comprises a control unit (e.g., controller) 1000, described herein, for the converter 130.

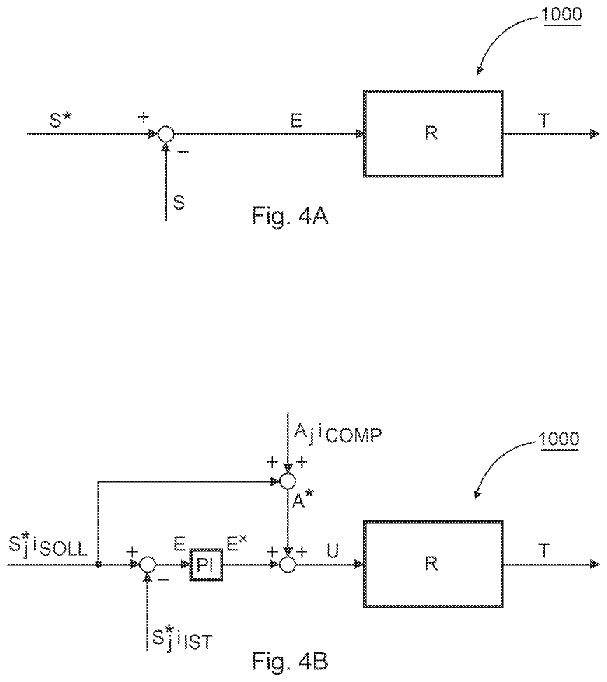

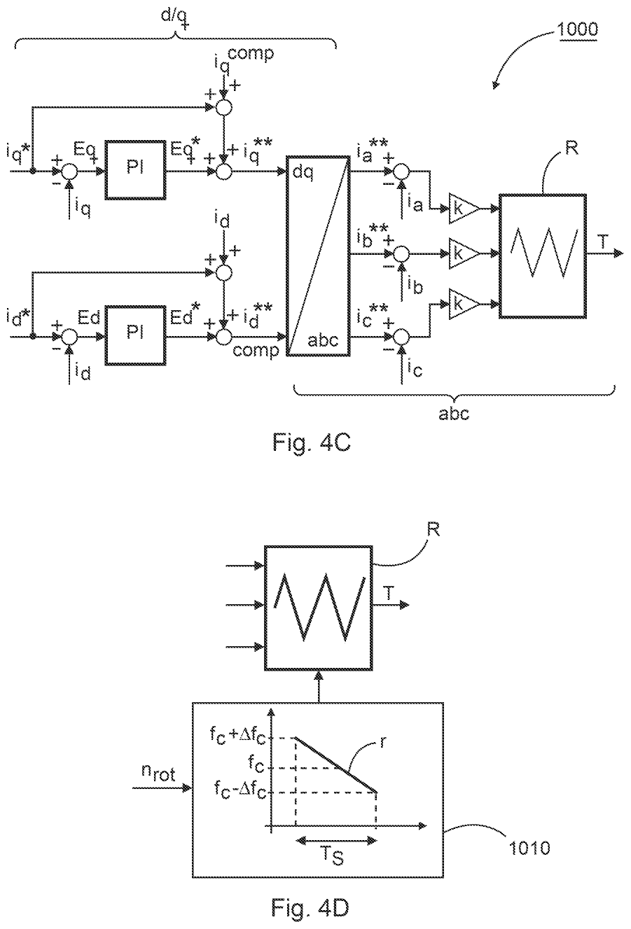

The control unit 1000 is therefore configured, in particular, to control the entire converter 130 with its two converter modules 130′, 130″, in particular as shown in FIG. 4, using driver signals T.

FIG. 3 schematically shows, by way of example, the structure of a converter 130, in particular of active rectifiers 132′, 132″, as shown in FIG. 2.

In this case, the converter 130 comprises, in particular, two active rectifiers 132′, 132″:

a first active rectifier 132′ for a or the first electrically three-phase system 122 and a second active rectifier 132″ for a or the second electrically three-phase system 124.

The active rectifiers 132′, 132″ are each connected, on the generator side, to a system 122, 124 of a or the generator 120 and are connected to an inverter 137′, 137″ via a DC voltage 135′, 135″, for example, as shown in FIG. 2, in particular.

The active rectifiers 132′, 132″ are each controlled using drive signals T by means of the control unit 1000 described herein and/or by means of a method described herein, in particular in order to respectively inject a three-phase alternating current iₐ′, i_{b}′, i_{c}′, iₐ″, i_{b}″, i_{c}″ in the stator of the generator 120.

FIG. 4A schematically shows, by way of example, the structure of a control unit (e.g., controller) 1000 of a converter 130, in particular for an active rectifier 132′, 132″.

The control unit 1000 determines a distortion variable E from a target value S* and an actual value S.

The target value S* and the actual value S are preferably physical variables of the converter, for example an alternating current Lso11 to be generated by the active rectifier 132′, 132″ or an alternating current List generated by the active rectifier 132′, 132″.

The distortion variable E is preferably determined from a difference between the target value S* and the actual value S and can therefore also be referred to as a closed-loop control error or measurement error. If the target value S* is a target current I_soll and the actual value S is an actual current I_ist, the distortion variable E can also be referred to as a distortion current.

The distortion variable E, in particular the distortion current, is compared with a signal R, for example a ramp signal, in order to generate the driver signals T for the converter 130, in particular the active rectifier 132′, 132″.

For example, the distortion variable E can be functionally compared with the carrier signal R in such a manner that each point of intersection between the distortion variable E and the carrier signal R is used as a trigger point for a driver signal T.

For this purpose, the carrier signal R may be, for example, in the form of a triangular signal, in particular with or without hysteresis.

The control unit 1000 is therefore in the form of a (ramp) comparison controller, in particular.

FIG. 4B schematically shows, by way of example, the structure of a control unit 1000 of a converter 130 in one preferred embodiment, in particular for an active rectifier 132′, 132″.

The control unit 1000 determines a distortion variable E from a target value S* and an actual value S.

The target value S* and the actual value S are, for example, physical variables generated by the converter, for example a current generated by the converter.

The distortion variable E may be determined, for example, from a difference between the target value S* and the actual value S and may therefore also be referred to as a closed-loop control error, for example.

The distortion variable E is then integrated by means of a PI element to form an extended distortion variable E*.

Depending on the design of the controller 1000 and/or the physical variables used, a gain k of the distortion variable E and/or a gain of the extended distortion variable E* by a factor of k may be expedient, where k is preferably between 2 and 10.

In addition, the target value S* is fed forward and is added to an offset A or a compensation value to form an extended offset A*.

The offset A or compensation value takes into account an operating point of the converter, for example.

The extended offset A* is then added to the extended distortion variable E* to form a control variable U which is compared with a carrier signal R in order to generate driver signals T for the converter 130.

For example, the control variable U can be functionally compared with the carrier signal R in such a manner that each point of intersection between the control variable U and the carrier signal R is used as a trigger point for a driver signal T.

FIG. 4C schematically shows, by way of example, the structure of a control unit 1000 of a converter 130 in a further preferred embodiment, in particular for an active rectifier 132′, 132″.

The control unit 1000 is constructed substantially as in FIG. 2, wherein the target value S*, the actual value S and the offset A are present in d/q coordinates and are additionally converted into abc coordinates.

The target value S* is a target current value i_{d}*, i_{q}* in d/q coordinates.

The d component of the target current i_{d}* is first of all compared with the d component of the actual current i_{d}. In particular, a difference is formed from the d component of the target current i_{d}* and the d component of the actual current i_{d} in order to determine a d component of the distortion current E_{d}.

The distortion current E_{d} is then passed via a PI element or PI controller in order to obtain an integrated distortion current E_{d}*.

In addition, the d component of the target current i_{d}* is fed forward and is added to a d component of a compensation current i__{comp}d and is added to the integrated distortion current E_{d}* in order to obtain a control variable i_{d}**.

Furthermore, the q component of the target current iq* is first of all compared with the q component of the actual current iq. In particular, a difference is formed from the q component of the target current iq* and the q component of the actual current i_{q} in order to determine a q component of the distortion current E_{q}.

The distortion current E_{q} is then passed via a PI element or PI controller in order to obtain an integrated distortion current E_{q}*.

In addition, the q component of the target current i_{q}* is fed forward and is added to a q component of a compensation current i__{comp}q and is added to the integrated distortion current E_{q}* in order to obtain a control variable i_{q}**.

The control variables i_{d}**, i_{q}** represent, in particular, the total closed-loop control error of a (stator) system of the generator and are broken down into abc coordinates iₐ**, i_{b}**, i_{c}** corresponding to the phases a, b, c of the system and are compared with the actual currents iₐ, i_{b}, i_{c} of the respective phase a, b, c, are then possibly amplified and compared with a triangular signal R, in particular in order to determine the driver signals T for the switches of the active rectifier.

Each electrical system 122, 124 preferably has an active rectifier 132′, 132″ which is respectively controlled by a control unit 1000 described herein using the driver signals T.

FIG. 4D schematically shows, by way of example, a control module (e.g., control circuit) 1010 of a control unit 1000 for varying a frequency of the signal.

The control module 1010 is configured to change the frequency f_{R} of the signal R, for example in a predetermined frequency range Δf.

This can be carried out using a ramp r, for example.

The slope or rise of the ramp r is based in this case on the predetermined frequency range Δf and the period duration of the stator currents Tₛ, for example on the basis of the number of pole pairs p of the generator and/or the rotor speed nᵣₒₜ of the generator, preferably by means of

$${T}_{s} = \frac{60}{{n}_{r o t} * p} .$$

For example, if the rotor speed is approximately 7.7 rpm and the number of pole pairs of the generator is 57, the period duration of the stator currents is approximately 136.7 ms.

In one preferred embodiment, and if the generator has two (stator) systems, this frequency change or smearing is selected for both systems.

The frequency variation for smearing is, for example, 5% of the frequency of the carrier signal. If the carrier signal has a frequency of 700 Hz, for example, the frequency variation for smearing is 35 Hz.

It is therefore also proposed, in particular, to select the same smearing for a plurality of systems.

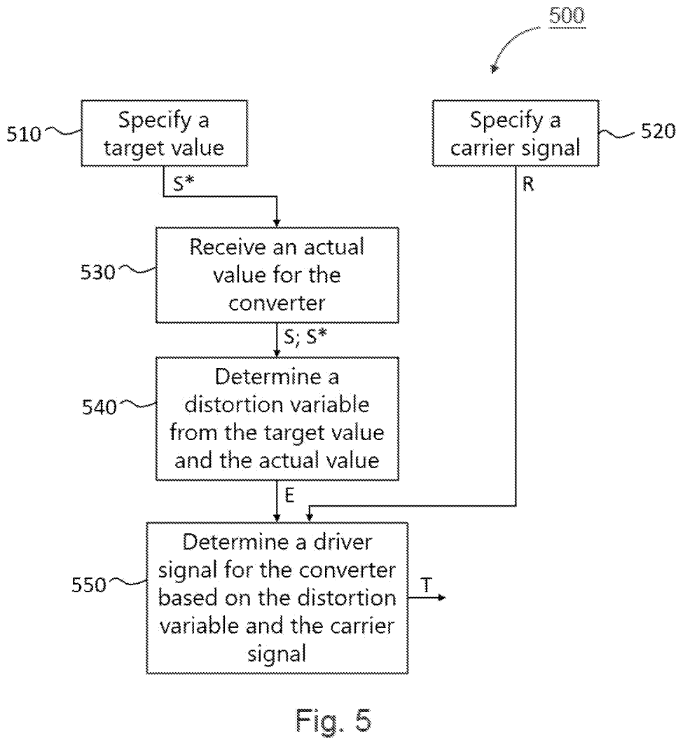

FIG. 5 schematically shows, by way of example, the sequence of a method 500 for controlling a converter 130, in particular an active rectifier 132′, 132″, in one embodiment.

In a first step 510, at least one target value S* is specified for the converter 130.

In addition, in a further step 520, a signal R is specified for the converter 130.

In a further step 530, an actual value S, in particular of the converter 130, is then captured.

In a further step 540, a distortion variable E is then determined from the target value S* specified in this manner and the actual value S captured in this manner.

A driver signal T for the converter 130, and in particular for the switches of the converter 130, is determined from the distortion variable E determined in this manner and the signal R, for example by means of comparison.

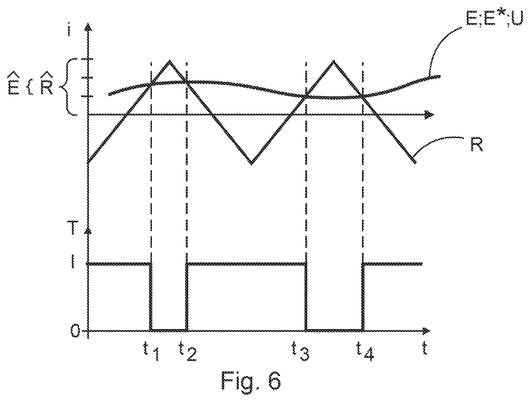

FIG. 6 schematically shows, by way of example, determination of a driver signal T for the converter on the basis of the distortion variable E and the carrier signal R.

The carrier signal R is designed as described herein.

In particular, the carrier signal R has an amplitude \hat{R} and a frequency f_{R}.

The distortion variable E, for example, is compared with this carrier signal R in order to generate corresponding driver signals T.

The distortion variable E is likewise designed as described herein.

In particular, the distortion variable E has an amplitude Ê and a frequency f_{E}.

For example, a carrier signal R in the form of a triangle and the distortion variable E are used to determine the driver signals T.

The carrier signal R has a frequency of approximately 700 Hz, for example. The distortion variable has a frequency of approximately 50 Hz, for example. In addition, the amplitude of the carrier signal is at least twice as large as the amplitude of the distortion variable.

If the present value of the distortion variable E is greater than the carrier signal R, the driver signal T is equal to 1 and accordingly a switch of the converter is at position 1, that is to say is switched on, for example.

If the distortion variable E, for example, then falls below the carrier signal R at the time t1, the driver signal T becomes equal to 0 and the corresponding switch of the converter is switched to position 0, that is to say is switched off, for example.

If the distortion variable E then exceeds the carrier signal R again at the time t2, the driver signal T becomes equal to 1 and the corresponding switch of the converter is switched to position 1 again.

A corresponding procedure then takes place at the times t3 and t4.

However, the driver signals T can also be accordingly determined using the extended distortion variable E* described herein or the modulation signal U described herein.

### LIST OF REFERENCE SIGNS

100 Wind power installation

100′ Electrical phase section, in particular of the wind power installation

100″ Detail of the electrical phase section

102 Tower, in particular of the wind power installation

104 Nacelle, in particular of the wind power installation

106 Rotor, in particular of the wind power installation

108 Rotor blade, in particular of the wind power installation

110 Hub, in particular of the wind power installation

120 Generator, in particular of the wind power installation

122 First electrical system, in particular of the generator

124 Second electrical system, in particular of the generator

130 Converter, in particular power converter of a wind power installation

130′ Converter module, in particular for the first electrical system

130″ Converter module, in particular for the second electrical system

132 Active rectifier

132′ Active rectifier module, in particular for the first electrical system

132″ Active rectifier module, in particular for the second electrical system

135′ DC voltage, in particular for the first electrical system

135″ DC voltage, in particular for the second electrical system

137 Inverter

137′ Inverter module, in particular for the first electrical system

137″ Inverter module, in particular for the second electrical system

140 Node

150 Transformer, in particular of the wind power installation

160 Wind power installation control unit

162 Current capture, in particular of the wind power installation control unit

162 Voltage capture, in particular of the wind power installation control unit

500 Method for controlling a converter

510 Step: Specify a target value

520 Step: Specify a signal

530 Step: Capture an actual value

540 Step: Determine a distortion variable

550 Step: Determine a driver signal

1000 Control unit, in particular of the converter

1010 Control module, in particular of the control unit

2000 Electrical supply network

f_{R} Frequency, in particular of the signal

i_compCompensation current, in particular for the active rectifier

i_comp_{d} d component, in particular of the compensation current

i_comp_{q} q component, in particular of the compensation current

ig Total current, in particular of a system of the generator

iG Total current, in particular of the converter

i_{d} d component, in particular of the actual alternating current

i_{q} q components, in particular of the actual alternating current

i_{d}* d component, in particular of the target alternating current

i_{q}* q components, in particular of the target alternating current

i_{d}** d component, in particular of the distortion current

i_{q}** q components, in particular of the distortion current

iₐ Alternating current of a first phase, in particular of the generator

i_{b} Alternating current of a second phase, in particular of the generator

i_{c} Alternating current of a third phase, in particular of the generator

iₐ′ First alternating current, in particular of a first active rectifier

i_{b}′ Second alternating current, in particular of a first active rectifier

i_{c}′ Third alternating current, in particular of a first active rectifier

iₐ″ First alternating current, in particular of a second active rectifier

i_{b}″ Second alternating current, in particular of a second active rectifier

i_{c}″ Third alternating current, in particular of a second active rectifier

i_ist Actual alternating current, in particular of the active rectifier

i_soll Target alternating current, in particular of the active rectifier

nᵣₒₜ Speed, in particular of the generator

p Number of pole pairs of the generator

r Ramp, in particular for changing the frequency

A Offset

A* Extended offset

E Distortion variable, in particular distortion current

E* Extended distortion variable

R Carrier signal

S Actual value, in particular of an electrical current

S* Target value, in particular of the electrical current

T Driver signals, in particular for the active rectifier

Tₛ Period duration, in particular of a ramp

U Modulation signal

ΦPhase angle, in particular between the first signal and the second signal

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for controlling a generator-side active rectifier of a power converter of a wind power installation, the method comprising:
specifying a target value for the converter;
specifying a carrier signal for the converter;
receiving an actual value indicative of a current of an electrical system of the generator;
determining a distortion variable from the target value and the actual value; and
determining driver signals for the converter based on the distortion variable and the carrier signal.

2. The method according to claim 1, comprising:
converting the distortion variable to form an extended distortion variable or a modulation signal.

3. The method according to claim 2, wherein the extended distortion variable or the modulation signal takes into account at least one system state of the converter.

4. The method according to claim 2, wherein converting the distortion variable includes amplifying or integrating the distortion variable.

5. The method according to claim 2, wherein determining the driver signals includes comparing the distortion variable, the extended distortion variable, or the modulation signal with the carrier signal.

6. The method according to claim 1, wherein determining the driver signals includes:
determining the driver signals based on an offset that takes an operating point into account; or
determining the driver signals by feeding forward the target value.

7. The method according to claim 1, wherein the target value is a target current value for the current of the electrical system of the generator of the wind power installation, and wherein the electrical system is a stator of the generator of the wind power installation.

8. The method according to claim 1, comprising:
setting a single-phase current of the electrical system based on the carrier signal.

9. The method The method according to claim 1, comprising:
generating the carrier signal as a triangular signal, a sinusoidal signal, or a square-wave signal.

10. The method according to claim 2,
wherein:
the carrier signal has an amplitude and a frequency,
the distortion variable has an amplitude and a frequency,
the extended distortion variable has an amplitude and a frequency,
the modulation signal has an amplitude and a frequency, and
wherein:
the amplitude of the carrier signal is greater than the amplitude of the distortion variable, the amplitude of the extended distortion variable, or the amplitude of the modulation signal, or
the frequency of the carrier signal is greater than the frequency of the distortion variable, the frequency of the extended distortion variable, or the frequency of the modulation signal.

11. The method according to claim 10, wherein:
the amplitude of the carrier signal is five times greater than the amplitude of the distortion variable, the amplitude of the extended distortion variable, or the amplitude of the modulation signal, and/or
the frequency of the carrier signal is ten times greater than the frequency of the distortion variable, the frequency of the extended distortion variable, or the frequency of the modulation signal.

12. The method according to claim 1, wherein the actual value representative of the current includes a three-phase overall system and each phase of the three-phase overall system.

13. The method according to claim 1, wherein the target value, the actual value, the distortion variable, and/or an offset are in d/q coordinates.

14. The method according to claim 1, wherein:
the target value is first target value of a first electrical system of the generator, the carrier signal is a first carrier signal of the first electrical system, the actual value is a first actual value of the first electrical system, the distortion variable is a first distortion variable of the first electrical system and the driver signals are first driver signals of the first electrical system,
the method includes:
specifying a second target value of a second electrical system of the generator;
specifying a second carrier signal of the second electrical system of the generator;
receiving a second actual value representative of a current of the second electrical system of the generator;
determining a second distortion variable of the second electrical system of the generator; and
determining second driver signals of the second electrical system of the generator,
the first carrier signal and the second carrier signal are identical and are offset from each other by a phase angle.

15. The method according to claim 14, wherein the phase angle is between 30° and 120°.

16. The method according to claim 1, comprising:
varying the carrier signal during operation.

17. The method according to claim 16, wherein the carrier signal is varied using a ramp function and based on a rotor speed of the generator and by a value in a frequency range between 0 and 10 per cent.

18. A controller, comprising:
an input; and
an output configured to be coupled to a converter, wherein the controller is configured to:
specify a target value for the converter;
specify a carrier signal for the converter;
receive an actual value representative of a current of an electrical system of a generator;
determine a distortion variable from the target value and the actual value; and
determine driver signals for the converter based on the distortion variable and the carrier signal.

19. A wind power installation, comprising:
a controller as claimed in claim 18; and
the converter, wherein the output of the controller is coupled to the controller.

20. The wind power installation according to claim 19, wherein the converter has at least one generator-side active rectifier that is operated using the controller.

21. The wind power installation according to claim 19, wherein:
the generator includes two stator systems that are offset from each other and coupled to an active rectifier, and
the controller separately controls each stator system of the two stator systems.
